(19) United States
(12) Patent Application Publication
(10) Pub. No.: US 2019/0392739 A1
(43) Pub. Date: Dec. 26, 2019

(54) PROJECTION SYSTEM AND PROJECTION METHOD

(71) Applicant: KIMURA CORPORATION, Tokyo (JP)

(72) Inventors: Tomoei KIMURA, Tokyo (JP); Naoki HASHIMOTO, Tokyo (JP)

(21) Appl. No.: 16/481,774

(22) PCT Filed: Jan. 31, 2018
(86) PCT No.: PCT/JP2018/003294

§ 371 Date: Jul. 29, 2019

(30) Foreign Application Priority Data
Jan. 31, 2017 (JP) 2017-016104

(51) Int. Cl. G09F 19/18; H04N 9/31; G06F 3/01; G09F 23/00; E03D 9/00

(52) U.S. Cl. CPC G09F 19/18; H04N 9/3185; E03D 9/00; G09F 23/00; G06F 3/017

(57) ABSTRACT

The present invention provides a technology for correcting a projection image in accordance with a user's position. In particular, by moving the projection position according to the position of each user, it is possible to have an image displayed at positions at which the image is easily viewable for the user. The projection system according to the present invention is provided with: a detection unit that detects a position of a user who is using a booth; an image projection unit that projects an image on a prescribed projection plane of each booth; a movement control unit that moves a projection position on the basis of the user's position; and a correction unit that corrects distortion of the image in accordance with the user's position.

### TECHNICAL FIELD

The present invention relates to a projection system and a projection method.

### BACKGROUND ART

Advertising media that displays information such as images, etc. by a flat display, a projector or the like, so-called digital signage has been recently widely spread (for example, Patent document 1). The digital signage has advantages that it is easier to update display content than paper media, many kinds of display content can be periodically switched and displayed by one display, and displays of many displays can be simultaneously updated by distributing data through a communication line.

### CITATION LIST

### Patent Document

[Patent document1] Japanese Patent Laid-Open No. 2009-289128

### SUMMARY OF THE INVENTION

### Problems to be Solved by the Invention

The digital signage is generally installed at places where many people see it, such as train stations, airports, shopping malls, etc. However, the digital signage has been placed at various places due to the spread in recent years, and there have been also proposals for installation in toilet booths.

However, when the digital signage is installed in a limited space inside the toilet booth, it has been difficult to install a large-size flat display. Furthermore, when a display is installed at a position where a user's hand can easily reach the display, the display may be destroyed or taken away. Therefore, it is conceivable to install a projector at a high position such as a ceiling and project from the projector onto an inner wall of the toilet booth. However, when the projector is installed at an upper side to project obliquely to the inner wall of the booth which is a projection target surface, a projection image is distorted, and thus it is necessary to correct the distortion according to a projection angle. However, since the amount of correction required at this time also differs depending on the position of a user who views the image, there is a problem that even when correction is uniformly performed, an appropriate display is not obtained.

Therefore, the present invention has an object to provide a technique of correcting a projection image according to the position of a user.

### Means for Solving the Problems

In order to solve the foregoing problem, a projection system according to the present invention comprises:

a detection unit that detects a position of a user who uses a booth;

an image projection unit that projects an image onto a projection target surface determined for the booth; and

a correction unit that performs correction of distortion of the image according to the position of the user.

The projection system may further comprise a movement control unit that moves a projection position based on the position of the user, wherein the correction unit may correct the image to be projected to the projection position based on the projection position.

In the projection system, the detection unit may determine a viewpoint position of the user as the position of the user, and the movement control unit may move the projection position based on the viewpoint position.

In the projection system, the image projection unit may be provided at an upper portion of the booth, when the user enters the booth and closes a door at a doorway of the booth, the image projection unit may project the image with an inner wall of the door set as the projection target surface, when the user opens the door and exits, the image projection unit may project the image from the upper portion of the booth through the doorway onto a floor surface, and the floor surface may be set as the projection target surface.

In the projection system, the booth may be provided with a toilet bowl, and when the user is not seated on the toilet bowl, the toilet bowl may be set as the projection target surface.

The projection system may further comprise:

an action detection unit that detects an operation of the user;

a gesture determination unit that determines whether a user's action corresponds to a predetermined gesture; and

an image control unit that controls the image to be projected according to the gesture when the user's action corresponds to the gesture.

In order to solve the foregoing problem, a projection method executes, by a computer:

a step of detecting a position of a user using a booth by a detection unit;

a step of causing an image projection unit to project an image onto a projection target surface determined for the booth; and

performing correction of distortion of the image according to the position of the user.

The projection method may further execute a step of moving a projection position based on the position of the user to correct the image to be projected to the projection position based on the projection position in the step of performing the correction.

In the projection method, the detection unit may determine a viewpoint position of the user as the position of the user, and move the projection position based on the viewpoint position.

In the projection method, the image projection unit may be provided at an upper portion of the booth, when the user enters the booth and closes a door at a doorway of the booth, the image projection unit may project the image with an inner wall of the door set as the projection target surface, when the user opens the door and exits, the image projection unit may project the image from the upper portion of the booth through the doorway onto a floor surface, and the floor surface may be set as the projection target surface.

In the projection method, the booth may be provided with a toilet bowl, and when the user is not seated on the toilet bowl, the toilet bowl may be set as the projection target surface.

The projection method may execute:

a step of detecting an operation of the user;

a step of determining whether a user's action corresponds to a predetermined gesture; and

a step of controlling the image to be projected according to the gesture when the user's action corresponds to the gesture.

The present invention may be a program for causing a computer to execute the projection method.

### Effects of the Invention

According to the present invention, a technique of correcting a projection image according to the position of a user can be provided.

### BRIEF DESCRIPTION OF THE DRAWINGS

FIG. 1 is a diagram illustrating a configuration of a projection system according to a first embodiment.

FIG. 2 is a diagram illustrating an example of facilities having the projection system.

FIG. 3 is a diagram illustrating an example of toilet facilities.

FIG. 4 is a perspective view illustrating a booth installed in the toilet facilities.

FIG. 5 is a plan view illustrating the booth.

FIG. 6 is a front view illustrating the booth.

FIG. 7 is a diagram illustrating a booth the door of which is a hinged door.

FIG. 8 is a diagram illustrating a booth the door of which is a sliding door.

FIG. 9 is a diagram illustrating an example of a controller.

FIG. 10 is a device configuration diagram illustrating an example of a computer.

FIG. 11 is a schematic configuration diagram of a projector.

FIG. 12 is an explanatory diagram of a method of correcting distortion of a projection image.

FIG. 13 is an explanatory diagram of a projection method according to the first embodiment.

FIG. 14 is a diagram illustrating a configuration of a second embodiment.

FIG. 15 is a diagram illustrating an example of the arrangement of sensors that detects a user's gesture.

FIG. 16 is a diagram illustrating a projection method in a third embodiment.

FIG. 17 is a diagram illustrating an example of an image projected onto a toilet bowl.

FIG. 18 is a diagram illustrating a projection method in the third embodiment.

FIG. 19 is a diagram illustrating an example of an image projected onto a floor surface.

FIG. 20 is a diagram illustrating an example of the arrangement of sensors that detect a user who approaches a booth.

### MODE FOR CARRYING OUT THE INVENTION

### First Embodiment

Hereinafter, embodiments of the present invention will be described with reference to the drawings. Note that the embodiments are examples of the present invention, and the configuration of the present invention is not limited to the following examples.

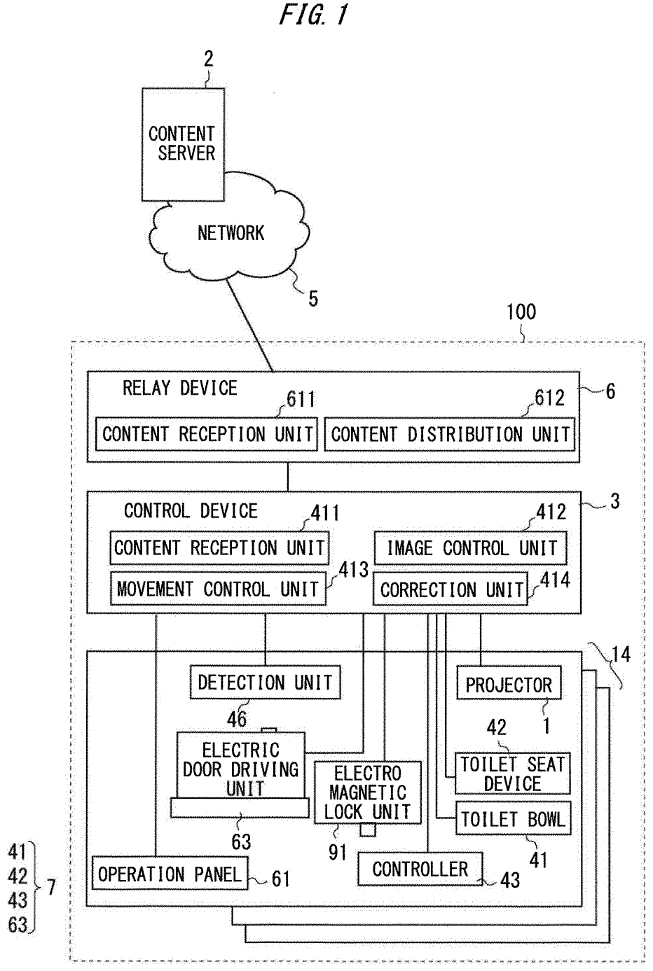

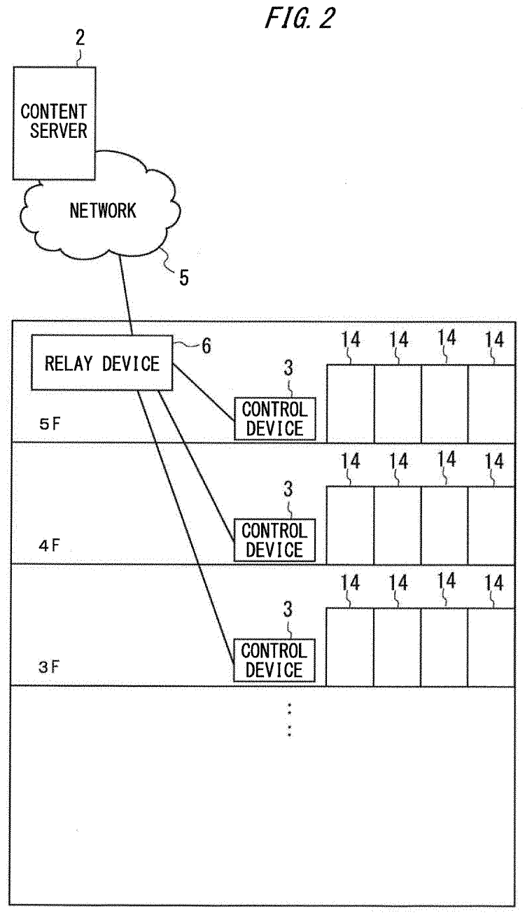

FIG. 1 is a diagram illustrating a configuration of a projection system according to a first embodiment, and FIG. 2 is a diagram illustrating an example of facilities having the projection system. The projection system 100 according to the present embodiment is a system that projects an image onto a projection target surface such as a wall or floor of a booth which a user mainly uses alone, and displays an image such as an advertisement for the user. The projection system 100 includes a detection unit 46, a projector (image projection unit) 1, a control device 3, and a relay device 6. In the example of FIG. 2, a plurality of booths 14 are installed on each floor of a building, and the control device 3 connected to the plurality of booths 14 is provided on each floor. Further, the control device 3 of each floor is connected to the relay device 6, and the relay device 6 is connected to a content server 2 via a network 5 such as the Internet.

The content server 2 periodically transmits content to the projection system 100, or transmits content in response to a request from the projection system 100. The relay device 6 of the projection system 100 receives the content transmitted from the content server 2 and distributes the content to the control device 3 of each floor. The control device 3 is connected to a detection unit 46 and the projector 1 which are provided in each booth 14, and causes the projector 1 to project an image based on the content to a projection position corresponding to the position of the user detected by the detection unit 46.

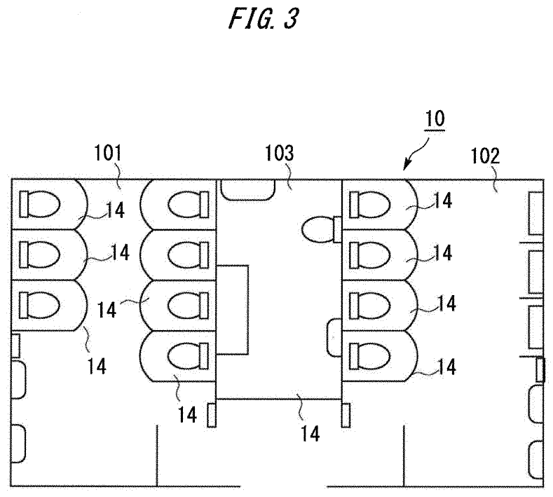

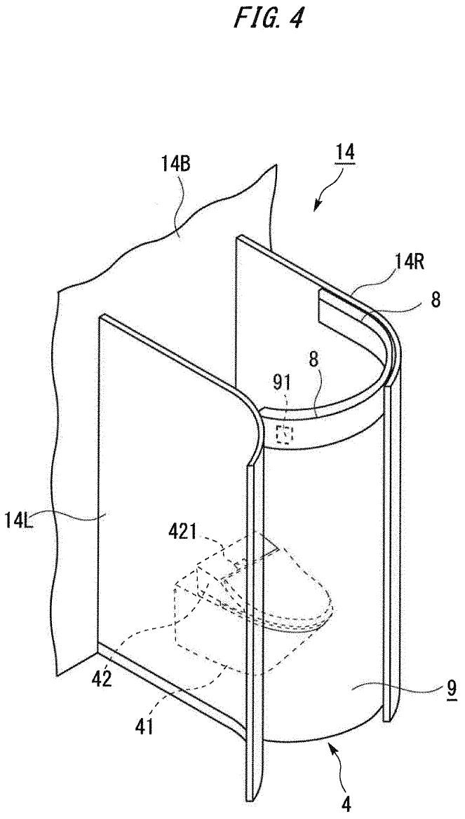

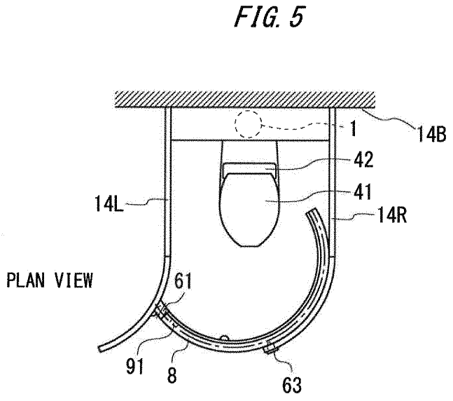

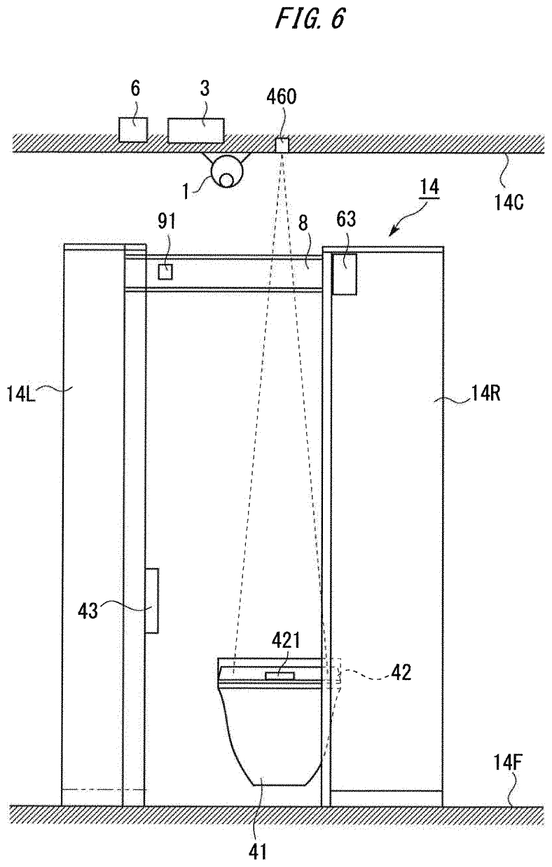

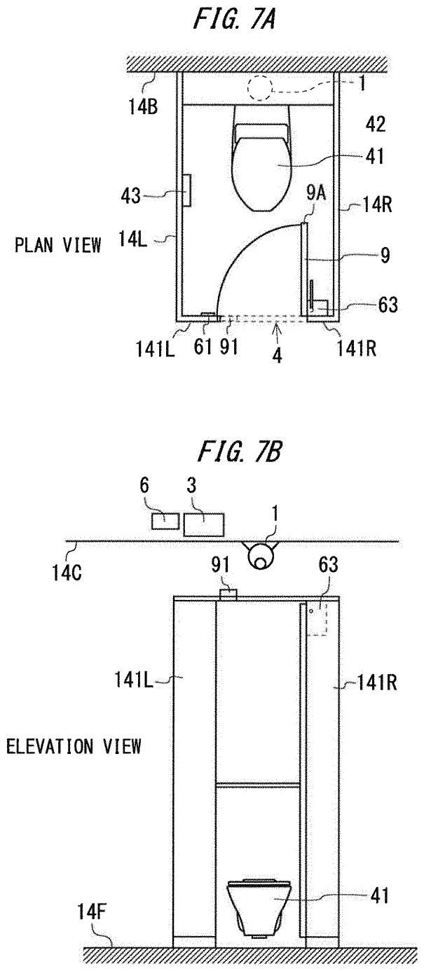

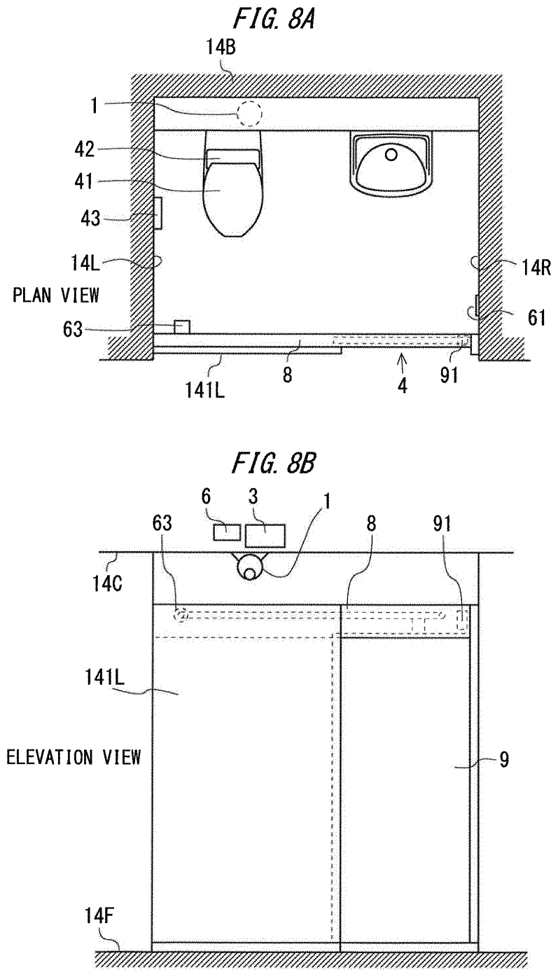

The booth 14 is, for example, a toilet booth that includes a toilet bowl 41 and is used by the public at commercial facilities such as a department store or a station. FIG. 3 is a diagram illustrating an example of toilet facilities 10. FIG. 4 is a perspective view illustrating the booth 14 installed in the toilet facilities 10, FIG. 5 is a plan view illustrating the booth 14, FIG. 6 is a front view illustrating the booth 14, FIG. 7 is a diagram illustrating a booth 14 in which a door 9 is a hinged door, and FIG. 8 is a diagram illustrating a booth 14 in which a door 9 is a sliding door.

As illustrated in FIG. 3, the toilet facilities 10 are compartmented into, for example, female toilet facilities 101, male toilet facilities 102, and multipurpose toilet facilities 103. A plurality of booths 14 are installed in the female toilet facilities 101 and the male toilet facilities 102. It is illustrated as an example that the multipurpose toilet facilities 103 of FIG. 3 include one booth 14, the multipurpose toilet facilities 103 may include a plurality of booths 14. Here, the booth 14 is a space that is surrounded by a door, a wall and the like and provided with toilet equipment 7 normally used to relieve himself/herself by only one person at the same time. Note that the booth 14 is not strictly limited to being used by only one person, and may be one in which an assistant or an infant can enter the room together with the user at the same time.

The booth 14 has a pair of right and left-side walls 14L and 14R and a rear wall 14B which surround three sides, and a door 9 that opens and closes a doorway 4 of the booth 14. The toilet bowl 41 is installed in the booth 14 which is surrounded on four sides thereof by the side walls 14L and 14R, the rear wall 14B and the door 9. The walls 14L, 14R, and 14B and the door 9 surrounding the booth 14 may have a height extending from the floor surface 14F to the ceiling surface 14C, but in the present embodiment, a space is provided between the ceiling surface 14C and each of the right and left-side walls 14L, 14R and the door 9 to allow air flow as illustrated in FIG. 6.

Here, “right and left” mean the left side and the right side when facing the doorway 4 from the outside of the toilet, “front and rear” mean the front side and the rear side when sitting on the toilet bowl 41, and “upper and lower” mean the ceiling surface 14C side and the installation surface (floor) 14F side of the toilet bowl 41.

The right and left-side walls 14L and 14R are plate members each of which is J-shaped in cross-section, that is, forms a straight line on one side of the cross-section and a curved line on the other side of the cross-section, and has a planar rear portion and a front portion having a quadric surface (see FIGS. 4 and 5). When there are adjacent booths 14, the left-side wall 14L may also serve as the right-side wall 14R of another left next booth 14 on the left-hand side of the booth 14, and the right-side wall 14R may also serve as the left-side wall 14L of another right next booth 14 on the right-hand side of the booth 14.

A guide rail 8 is installed on an inner upper portion of the right-side wall 14R (see FIG. 4). The guide rail 8 held by the right-side wall 14R at one end portion of the guide rail 8 passes an upper portion of the doorway 4, and is fixed to the left-side wall 14L at the other end of the guide rail 8. Note that although not illustrated in FIG. 4, a guide rail 8 is also installed inside the left next booth 14 on the left-side wall 14L serving as the right-side wall of the left next booth 14. Furthermore, a door driving unit 63 is installed in the vicinity of the guide rail 8 at an upper portion of a front end of the right-side wall 14R. The door 9 is installed on the guide rail 8 in a hanging state, and the door 9 is moved along the guide rail 8 by the door driving unit 63, thereby opening or closing the doorway 4. The guide rail 8 is provided with a lock 91, and locking and unlocking of the lock 91 is controlled in conjunction with driving of the door 9 by the door driving unit 63.

An operation panel 61 which has opening and closing buttons of the door 9 and is electrically connected to the door driving unit 63 is installed on the inner surface of the left-side end portion of the door 9. When the closing button of the operation panel 61 is pushed by a user's operation, the door driving unit 63 operates to close the door 9, and the lock 91 is engaged with the door 9 to lock the door 9 in a state where the left end of the door 9 abuts against the left-side wall 14L, thereby preventing opening of the door.

When the opening button of the operation panel 61 is pushed, the door driving unit 63 drives the lock 91 to release the engagement with the door 9, thereby unlocking the door 9, and drives the door 9 in an opening direction. The lock 91 is not limited to the configuration in which the lock 91 is provided to the guide rail 8 and engaged with the door 9, and may be configured so as to be provided to the left-side wall 14L, the right-side wall 14R, the floor surface 14F or the like and engaged with the door 9, thereby preventing opening of the door.

Conversely, the lock 91 may be configured so as to be provided with the door 9 and engaged with the guide rail 8, the left-side wall 14L, the right-side wall 14R, the floor surface 14F or the like, thereby preventing opening of the door. Note that in this example, when the door 9 is closed, the lock 91 locks the door 9 to prevent the door 9 from opening, but the lock 91 may be omitted in the case of a configuration in which the closed door 9 cannot be easily opened from the outside, for example, a configuration in which a gear of the door driving unit 63 is not rotated even when another person applies force to manually open the door 9, and thus the door 9 does not move. As described above, since the operation panel 61 configured to open and close the door 9 is provided in the booth 14, a user who operates the operation panel 61 is present in the booth 14 in the state where the door 9 is closed.

Furthermore, after the user opens the door 9 and exits from the booth 14 after use of the booth 14, the door 9 is set to an open state until a next user enters the room and closes the door 9. Therefore, based on the opened or closed state of the door 9, when the door 9 is closed, it is detected that the user is present in the booth 14, and when the door 9 is opened, it is detected that the user is not present in the booth 14.

Note that with respect to the opened and closed states of the door 9, for example, the door driving unit 63 may be provided with a sensor (opening and closing sensor) that detects the position of the door 9, and it may be detected by the opening and closing sensor whether the door 9 is located at a closing position or opening position, or whether the door 9 is closed or opened may be detected based on a driving history of the door 9 by the door driving unit 63.

Note that FIGS. 4 to 6 illustrate the example of the toilet booth using the rotatable door 9, but the present invention is not limited to this example, and the door 9 may be configured as a hinged door as illustrated in FIG. 7 or may be configured as a sliding door as illustrated in FIG. 8.

The booth 14 illustrated in FIG. 7 is surrounded on three sides by a pair of right and left-side walls 14L and 14R and a rear wall 14B, a left front wall 141L is provided on the left side of a front surface, and a right front wall 141R is provided on the right side of the front surface, and an opening between the left front wall 141L and the right front wall 141R is the doorway 4. Moreover, the door 9 is slidably fitted to the left end of the right front wall 141R via a hinge (not illustrated). The door driving unit 63 is provided to an upper portion on a hinge side of the door 9, and the door 9 is driven to be opened and closed by the door driving unit 63. For example, the door driving unit 63 causes a door tip 9A of the door 9 to turn inward with the hinge as a central axis to set the doorway 4 to an opened state, and conversely the door driving unit 63 causes the door tip 9A to turn until the door tip 9A is received by the right end of the left front wall 141L, thereby setting the doorway 4 to a closed state.

The operation panel 61 configured to operate the opening and closing of the door driving unit 63 is provided inside the left front wall 141L.

An upper frame 142 is bridged between the upper ends of the left front wall 141L and the right front wall 141R, and the lock 91 is provided to the upper frame 142. The lock 91 is driven by the door driving unit 63 in conjunction with the opening and closing of the door 9, and when the door 9 is closed, the lock 91 engages with the door 9 to lock the door, thereby preventing opening of the door.

The booth 14 illustrated in FIG. 8 is surrounded on three sides by the side walls 14L and 14R and the rear wall 14B, the left front wall 141L is provided on the left side of the front surface, and an opening between the left front wall 141L and the front end of the right-side wall 14R is the doorway 4. Furthermore, the guide rail 8 is provided at the upper portions of the left front wall 141L and the right-side wall 14R, and the door driving unit 63 is provided along the guide rail 8. The door 9 is installed on the guide rail 8 in a hanging state, and the door 9 is moved along the guide rail 8 by the door driving unit 63 to open or close the doorway 4. The guide rail 8 is provided with the lock 91, and the locking and unlocking of the lock 91 is controlled by the door driving unit 63 in conjunction with driving of the door 9. For example, when the door 9 is closed, the lock 91 engages with the door 9 to lock the door 9, thereby preventing opening of the door.

The operation panel 61 configured to operate opening and closing of the door driving unit 63 is provided in the vicinity of the door 9 of the right-side wall 14R.

Returning to FIG. 1, the booth 14 is provided with toilet equipment 7 such as a toilet bowl 41, a toilet seat device 42, a controller 43, and the operation panel 61, a detection unit 46, and a projector 1.

The toilet seat device 42 is provided on the Western-style toilet bowl 41, and has a function of warming a seat surface on which a user seats and a cleaning function of discharging warm water to clean the anus and the private parts of the user. The toilet seat device 42 is provided with a seating sensor 421 that detects whether the user is seated, and when seating of the user is not detected after a predetermined time has elapsed since detection of the seating of the user, that is, it is determined that the user rises because he/she has relieved himself/herself, based on a detection result of the seating sensor 421, the toilet seat device 42 performs control of discharging washing water for cleaning the toilet seat, control of reducing the temperature of the seating surface to set a power saving mode when the user is not seated, etc. Note that the toilet bowl 41 is not limited to the Western-style, and may be a Japanese style. When a Japanese-style toilet bowl 41 is provided, the toilet seat device 42 is omitted. In this case, it may be detected by a human detection sensor or the like that the user sits down over the Japanese-style toilet bowl 41 and has entered a posture to relieve himself/herself, and this may be detected as seating of the user.

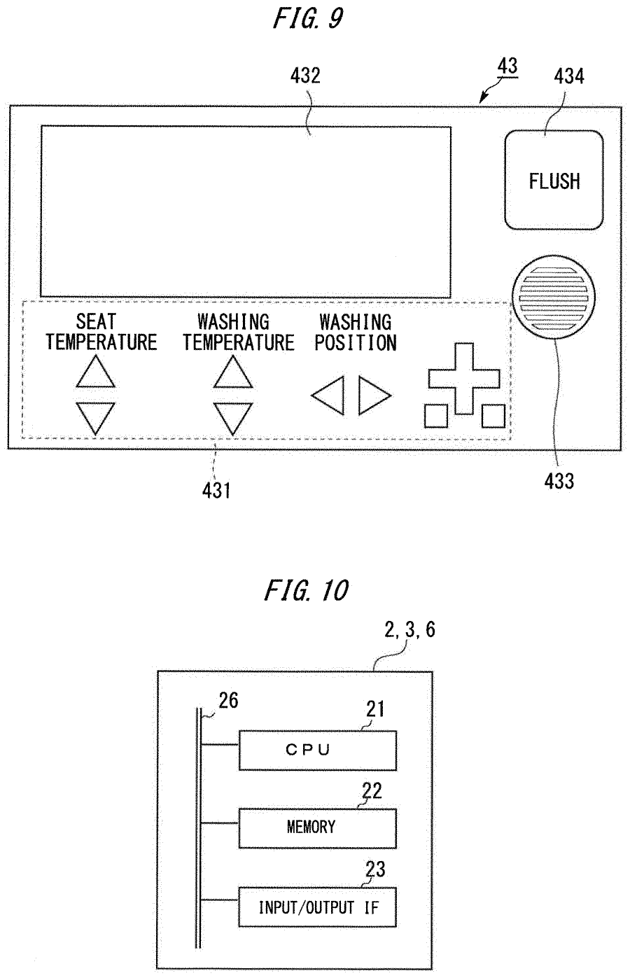

As illustrated in FIG. 9, the controller 43 has an operation unit 431 that performs operations such as temperature setting of the toilet seat device 42 and setting of a washing position. The controller 43 also has a display unit 432 and a speaker 433.

The display unit 432 displays information received from the control device 3 and the like as well as the set temperature of the toilet seat, the temperature of the warm water for washing, and the washing position.

The speaker 433 outputs an operation sound when the operation unit 431 is operated, an artificial sound simulating a sound generated when washing water for washing the toilet bowl flows, sounds constituting the content together with an image to be projected onto the projection target surface and the like.

The detection unit 46 is a sensor that detects the position of a user in the booth 14. The detection unit 46 is a sensor that detects the presence of the user by, for example, infrared rays, radio waves, ultrasonic waves, or the like. The detection unit 46 may be a passive type sensor that senses infrared rays emitted by the user to detect the presence of the user, or may be an active type sensor that transmits infrared rays, radio waves, or ultrasonic waves from a transmitter, and detects the presence of the user by capturing variation of the infrared rays, the radio waves or ultrasonic waves, which is caused by blocking or reflection by the user, by a receiver.

Particularly, in the present embodiment, an active distance sensor 460 is installed on the ceiling surface 14C located above each booth 14, and the distance to an object in the booth is detected based on a period of time from transmission of signal light of infrared rays or the like to the toilet bowl 41 until reception of reflection light reflected from the object in the booth, or by means of triangulation from a photodetection position at which reflection waves are detected by PSD (Position Sensitive Detector).

As illustrated in FIG. 6, in a state where no user is present in the booth 14, the sensor 460 detects the distance to the toilet bowl 41 because there is not any object blocking transmission waves between the sensor 460 and the toilet bowl 41. On the other hand, in a state where a user is seated on the toilet bowl 41, the sensor 460 detects the distance to the user because the transmission waves are reflected by the user. Information on the height of the user can be obtained by subtracting the distance to the user detected by the sensor 460 from the distance (height) between the floor surface 14F and the sensor 460. Usually, the highest site of the user is the head portion, and thus a position which is lower than the height information of the user by a predetermined distance (for example, 10 cm) is obtained as a viewpoint position. Note that a plurality of sensors 460 may be provided to transmit transmission waves not only just above the toilet bowl 41, but also toward the surrounding of the toilet bowl 41, determine distances to the surrounding of the toilet bowl 41, and set, as the position of the head portion of the user, a position nearest to the sensor 460 out of these distances, that is, a highest position out of the height information.

The detection unit that detects the user's height information is not limited to the distance sensor, and a light projector may be provided on the ceiling surface 14C to project a predetermined pattern of infrared rays into the booth, pick up an image of the pattern projected on an object in the booth by a camera, compare the predetermined pattern with the pattern projected on the object and determine the distance to the object present on the toilet bowl 41, that is, the height information of the object from the difference between the patterns.

Furthermore, the distance to the object present on the toilet bowl 41, that is, the height information of the object may be determined by a ToF distance image sensor. In this case, a human shape may be stored as a standard pattern, an object matching this standard pattern may be identified as a user by pattern matching, and a site of the object which matches the head portion of the standard pattern may be recognized to determine the height of the head portion and a viewpoint position.

A sensor of another device may be used as the detection unit 46. For example, the seating sensor 421 of the toilet seat device 42 or a sensor (not illustrated) for detecting that a user enters the booth 14 and operating lighting, air conditioning, a deodorizer, etc. may be used as the detection unit 46. Furthermore, the operation panel 61 or the door driving unit 63 may be used as the detection unit 46.

The control device 3 is a device that receives content from the content server 2 and controls the projector 1 to project an image of the content, and includes a content reception unit 411, an image control unit 412, a movement control unit 413, and a correction unit 414.

The content reception unit 411 receives content from the relay device 6. The content reception unit 411 may be configured to store content received from the relay device 6 into a memory to provide the content to the image control unit 412, or may be configured to provide content from the relay device 6 and provide the content to the image control unit 412 every time an image is projected.

The image control unit 412 transmits image information of the content received by the content reception unit 411 to the projector 1 to project an image. Note that the image control unit 412 may start the projection of the image when it is detected by the detection unit 46 that a user has entered the booth 14, and may stop the projection when the user has exited from the booth 14.

The movement control unit 413 moves the projection position by the image projection unit based on the position of the user detected by the detection unit 46. For example, when the seating sensor is turned on, it can be specified that the user is seated on the toilet bowl 41, that is, the user is positioned on the toilet bowl 41, and thus the projection position is controlled so that an image is projected to a position where the user seated on the toilet bowl 41 can easily see the image. Here, since the toilet bowl 41 is positionally fixed, when the user is seated on the toilet bowl 41, a viewpoint position within a horizontal plane is substantially the same for all users, but a viewpoint position in the height direction is different depending on the user's body height. Therefore, the movement control unit 413 detects the height information of the user by the detection unit 46, determines the projection position according to the height of the viewpoint for each user, and projects an image onto the projection position. Note that the height of the projection position may be set to, for example, the same height as the viewpoint position, or a height which is added with an offset value so as to be higher or lower by a predetermined distance than the viewpoint position. The height of the projection position is the height of a reference position such as the center of an image. In this example, the height of the projection position is indicated by an absolute value from the floor surface 14F, but may be indicated by a relative value from a viewpoint position or the like.

The correction unit 414 performs distortion correction of an image projected onto the projection position according to the projection position. Since the distortion of the image projected onto the projection target surface differs depending on the angle or the shape of the projection target surface at the projection position, a correction value for correcting this distortion is determined in advance according to the projection position, and stored (in an auxiliary memory). The correction value is read from the memory according to the projection position determined by the movement control unit 413, and the image is corrected according to the correction value. When the image is corrected as described above, a correction effect differs depending on the viewpoint position where the projected image is observed. Therefore, the correction unit 414 may correct distortion of an image to be projected onto a projection position according to the projection position and the viewpoint position. For example, a correction value for correcting this distortion is obtained in advance according to the projection position and the viewpoint position and stored in the memory, a correction value is read from the memory according to the projection position determined by the movement control unit 413 and the viewpoint position based on the detection result of the detection unit 46, and the image is corrected according to the correction value.

The relay device 6 is a device that provides content received from the content server 2 to the control device 3, and includes a content reception unit 611 and a content distribution unit 612.

The content reception unit 611 receives content from the content server 2 via the network 5 such as the Internet. The content distribution unit 612 stores content received from the relay device 6 in the memory, and when receiving a request for content from the control device 3, the content distribution unit 612 reads out the content and transmits the content to the control device 3. Every time the content distribution unit 612 receives a request for content from the control device 3, the content reception unit 611 may acquire the content from the content server 2, and every time content is acquired from the content server 2, the content distribution unit 612 may distribute the content to the control device 3.

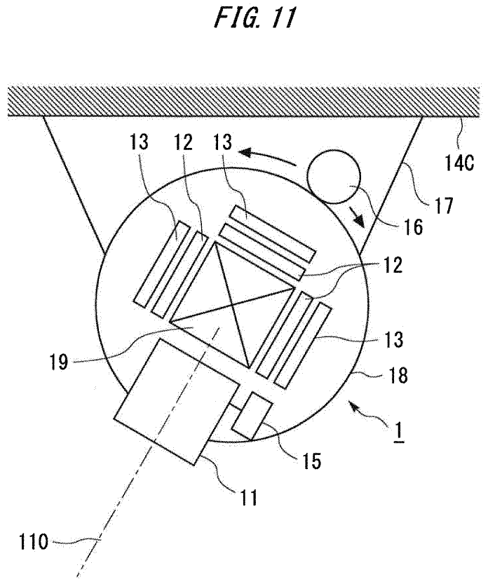

FIG. 10 is a device configuration diagram illustrating an example of a computer. The content server 2, the relay device 6, and the control device 3 are, for example, computers as illustrated in FIG. 10. A computer 200 has a CPU 21, a memory 22, an input/output IF (Interface) 23, and a communication bus 26. The CPU 21 is also called a processor. However, the CPU 21 is not limited to a single processor, and may have a multiprocessor configuration. A single CPU 21 to be connected via a single socket may have a multi-core configuration.

The memory 22 includes a main memory and an auxiliary memory. The main memory is used as a work area of the CPU 21, a memory area of programs and data, and a buffer area of communication data. The main memory is formed of, for example, Random Access Memory (RAM) or a combination of RAM and Read Only Memory (ROM). The main memory is a memory medium for which the CPU 21 caches programs and data and expands the work area. The main memory includes, for example, a flash memory, a RAM (Random Access Memory), and a ROM (Read Only Memory). The auxiliary memory is a memory medium for storing programs to be executed by the CPU 21, setting information of operations, and the like. The auxiliary storage device is, for example, an HDD (Hard-disk Drive), an SSD (Solid State Drive), an EPROM (Erasable Programmable ROM), a flash memory, a USB memory, a memory card, or the like.

The input/output IF 23 is an interface that inputs and outputs data to and from devices such as a sensor, an operation unit, and a communication module connected to the content server 2, the relay device 6, or the control device 3. Note that each of the above-described components may be provided in the form of a plurality of elements, or some of the components may not be provided.

In the content server 2, the CPU 21 functions as a processing unit that executes processing of reading out content from the memory 22 and transmitting the content to the relay device 6 by executing a program. In the relay device 6, the CPU 21 functions as respective processing units of the content reception unit 611 and the content distribution unit 612 illustrated in FIG. 1 by executing a program. In the control device 3, the CPU 21 functions as respective processing units of the content reception unit 411, the image control unit 412, the movement control unit 413, and the correction unit 414 illustrated in FIG. 1 by executing a program. However, the processing of at least some of the respective processing units described above may be provided by DSP (Digital Signal Processor), ASIC (Application Specific Integrated Circuit), or the like. Furthermore, at least some of the respective processing units may be a dedicated LSI (large scale integration) such as FPGA (Field-Programmable Gate Array) or another digital circuit. Furthermore, at least some of the respective processing units may be configured to include an analog circuit.

FIG. 11 is a schematic configuration diagram of the projector 1. The projector 1 includes a projection lens 11, a liquid crystal display unit (display element) 12, a light source 13, a prism 19, a lens driving unit 15, a projection position changing unit 16, a base 17, and a housing 18.

The liquid crystal display unit 12 is an element that displays an image based on the content, and in this example, the image is decomposed into three primary colors of light, and decomposed R (red), G (green), and B (blue) images are assigned to three liquid crystal display units one by one. The light source 13 illuminates each of the three liquid crystal display units 12. The prism 19 combines light fluxes of three primary colors transmitted through the three liquid crystal display units 12. The projection lens 11 projects the light fluxes combined by the prism 19 onto the projection target surface, and forms an enlarged image (color image) of the image displayed on each liquid crystal display unit 12. The lens driving unit 15 drives at least a part of the projection lens 11, and adjusts focus, tilt, and shift of the projection lens 11.

The base 17 is fixed to the ceiling surface 14C, and rotatably holds the housing 18 in which the projection lens 11, the liquid crystal display unit 12, the light source 13, the prism 19, and the lens driving unit 15 are accommodated. The projection position changing unit 16 changes the projection position of the image by rotating the housing 18 with respect to the base 17. In other words, the projector 1 is installed such that an optical axis 110 of the projection lens 11 directed to the projection target surface has a depression angle with respect to the ceiling surface 14C, and the projection position changing unit 16 changes the depression angle, whereby the position of the image projected onto the projection target surface is changed up and down.

<Correction Method>

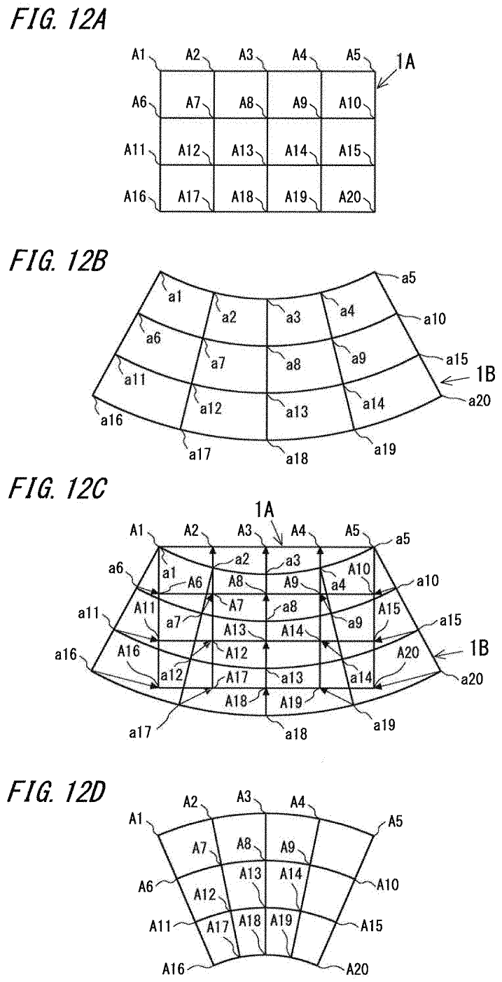

As illustrated in FIG. 11, the projector 1 of the present embodiment is installed on the ceiling surface 14C. Since the optical axis 110 of the projection lens 11 is directed obliquely downward and a vertical wall surface is set as the projection target surface, an image projected on the projection target surface has distortion. For example, when a grid-like calibration pattern 1A as illustrated in FIG. 12A is displayed on the liquid crystal display unit 12 of the projector 1 and projected onto the inner wall of the door 9 without correction, the projected calibration pattern 1B is distorted in a fan shape as illustrated in FIG. 12(B). This distortion is a combination of trapezoidal distortion caused by projecting obliquely downward from the ceiling surface 14C onto a vertical wall surface and arc-shaped distortion caused by projecting onto the pillar-shaped door 9 whose generation line is an arc.

In FIG. 12(A), a rectangle is divided vertically and horizontally by straight lines, and intersection points of the respective straight lines are indicated by A1 to A20. On the other hand, in FIG. 12(B), the intersection points corresponding to A1 to A20 in FIG. 12(A) are indicated by al to a20. As described above, the straight lines A1 to A5 and A16 to A20 in the horizontal direction in FIG. 12(A) become curved lines al to a5 and a16 to a20 which are curved downward in FIG. 12(B). Furthermore, in FIG. 12(B), the lower sides a16 to a20 are distorted more greatly than al to a5.

Here, the calibration pattern 1B projected onto the projection target surface as illustrated in FIG. 12(B) is imaged by a camera and compared with the original calibration pattern 1A as illustrated in FIG. 12(C), whereby the direction and amount of distortion at each of the points al to a20 are determined as indicated by arrows.

Then, as illustrated in FIG. 12D, an image to be displayed on the liquid crystal display unit 12 is subjected to deformation having the same amount as the distortion in an opposite direction to the direction of the distortion so as to offset the distortion under the projection, whereby the image can be projected in a rectangular shape. Note that the deformation amount and direction to offset the above distortion differ depending on the projection position or the viewpoint position, and thus for each projection position and each viewpoint position, the deformation amount and the direction to offset this distortion are determined, and stored as a correction value in the memory. The correction method is not limited to the above method, and instead of the grid pattern, a structured pattern such as a gray code may be used, or distortion measurement at a sub-pixel level by a phase shift method may be used.

The correction unit 414 of the control device 3 reads a correction value from the memory according to the projection position and the viewpoint position, and performs image processing based on this correction value to deform an image of the content, thereby performing the correction.

Note that trapezoidal distortion caused by projecting obliquely downward from the ceiling surface 14C onto a vertical wall surface out of the distortion under projection can also be optically corrected by shifting the projection lens 11 using the lens driving unit 15 of the projector 1. For example, the projection lens 11 is shifted so as to correct trapezoidal distortion of an image which is projected so as to have a predetermined height, and the calibration pattern 1B projected on the projection target surface is imaged by a camera under the above state, and compared with the original calibration pattern as illustrated in FIG. 12(C), and a correction value is determined so as to offset the distortion of the calibration pattern 1B. As a result, the trapezoidal distortion can be optically corrected, and the deformation amount (correction amount) caused by the image processing can be suppressed. Note that the correction amount of the projection lens 11 may be changed according to the projection position, or may be fixed to that at a predetermined projection position. For example, when the projection position is adjusted in the range of 800 mm to 1400 mm from the floor surface 14F, the shift amount of the projection lens 11 is fixed so as to correct an image projected to an intermediate height position of 1100 mm, and correction of distortion for change of the projection position according to the viewpoint position when the user is actually seated may be performed by image processing. In this case, the shift amount of the projection lens 11 may be a shift amount for correcting trapezoidal distortion when an average of viewpoint positions detected within a predetermined period is determined and the projection position is changed according to the averaged viewpoint position.

When the door 9 is configured to be flat as illustrated in FIGS. 7 and 8, distortion correction may be performed by adjusting the shift amount of the projection lens 11 according to the projection position without performing any correction based on image processing.

<Projection Method>

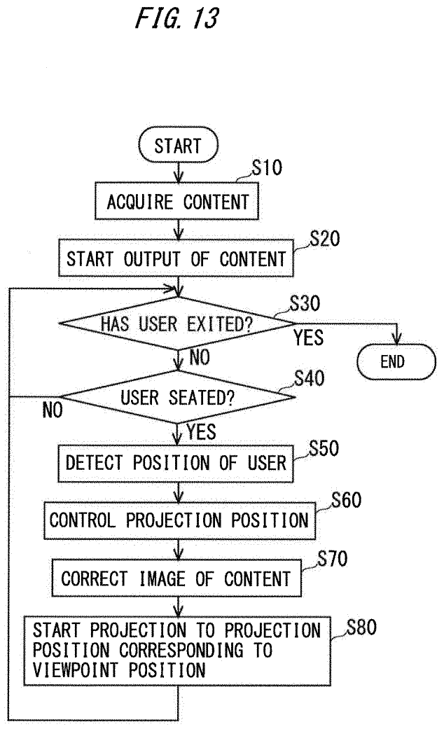

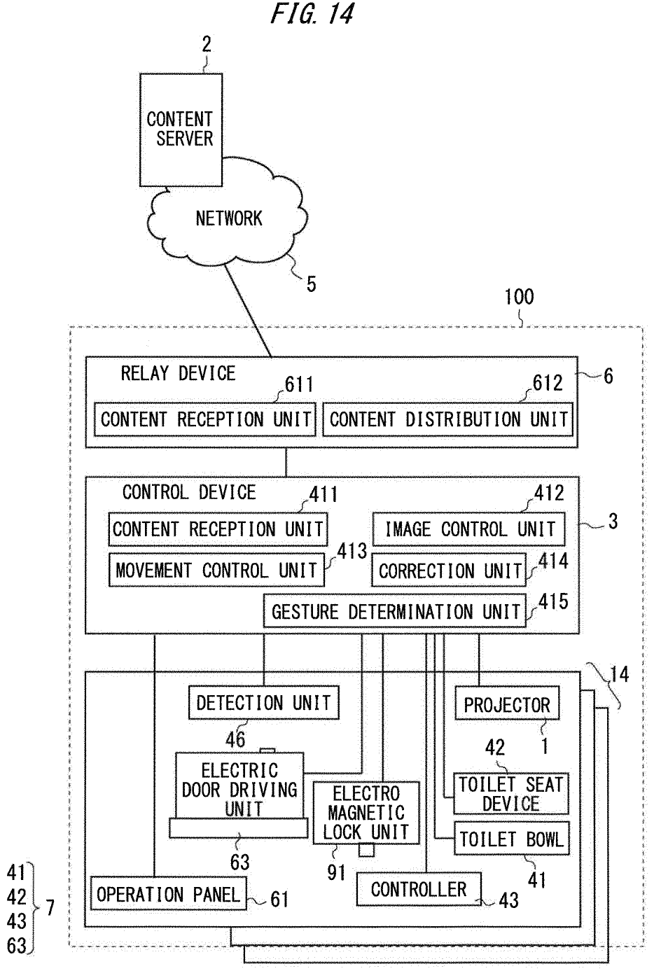

Next, a projection method in the projection system 100 of the present embodiment will be described. FIG. 13 is an explanatory diagram of a projection method executed by the control device 3 according to a program.

First, when the detection unit 46 such as a human detection sensor installed in the booth 14 detects doorway of a user, the control device 3 starts processing of FIG. 13. First, the control device 3 acquires content from the content server 2 or the memory (step S10). Then, the control device 3 causes an image to be projected to a predetermined projection position, and causes sound information of the content to be output from the speaker 433, thereby starting the output (reproduction) of the content (step S20). At this time, since it can be estimated that the user has entered the booth 14, it is before the user is seated on the toilet bowl 41 and thus the user is standing, an image is projected to a high position, for example, the maximum height of the adjustment range (for example, 1400 mm). Note that the projection position is not limited to the above position, and it may be set to a middle position in the adjustment range, or an average of viewpoint positions detected within a predetermined period may be determined to set the projection position according to the averaged viewpoint position.

The control device 3 further determines whether the user has exited from the booth 14 (step S30), and when the user has exited (step S30, Yes), the control device 3 ends the processing of FIG. 13. Note that the detection as to whether the user has exited may be performed by determining that the user has exited when the detection unit 46 such as a human detection sensor installed in the booth 14 has not detected the presence of the user, or by determining that the user has exited when it is detected that the lock 91 is unlocked or the door 9 is in an opened state. When it is determined that the user has not exited (Step S30, No), the control device 3 determines whether the user has been seated on the toilet bowl 41, that is, whether the seating sensor detects the presence of the user (step S40). Here, when the user is not seated (step S40, No), the control device 3 returns to step S30.

When it is determined that the user has been seated on the toilet bowl 41 (step S40, Yes), the control device 3 acquires height information of the user by the sensor 460, and determines a viewpoint position (step S50).

Next, the control device 3 determines a projection position based on the viewpoint position, and controls the projector 1 to project an image onto the position (step S60).

Furthermore, the control device 3 corrects the image of the content based on the correction value corresponding to the projection position (step S70), and causes the projector 1 to project a corrected image (step S80). Then, the control device 3 returns to step S30, and repeats these processing until the user has exited.

As described above, the projection system 100 according to the first embodiment can project an image for which distortion has been accurately corrected by performing distortion correction on the image according to the position of the user. In particular, by moving the projection position based on the position of the user, the projection system 100 according to the first embodiment can display an image at each position where the image is easily viewable for each user.

Note that in this example, the projection of an image is started when the user has entered the booth 14. However, the present invention is not limited to this example, and the step S20 may be omitted, and after the user has been seated on the toilet bowl 41, the projection position may be determined in conformity with the user's viewpoint position to start the projection.

### Second Embodiment

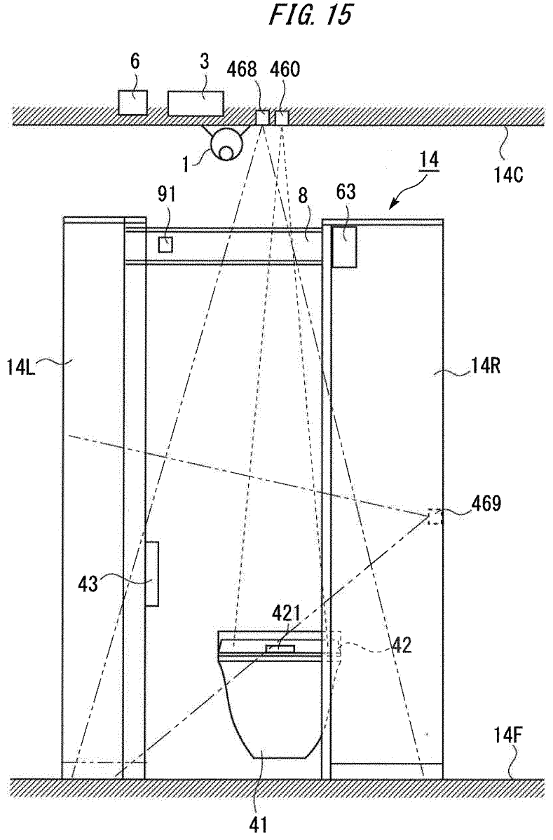

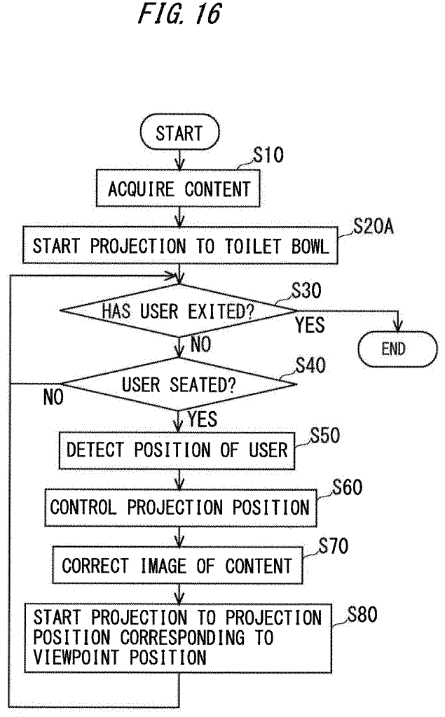

As compared with the first embodiment described above, a second embodiment is added with a configuration that controls a projection image according to a user's gesture. Note that the other configuration is the same, and thus the same components are represented by the same reference numerals and symbols, and description thereof is omitted. FIG. 14 is a diagram illustrating a configuration of the second embodiment, and FIG. 15 is a diagram illustrating an arrangement example of sensors for detecting a user's gesture.

As illustrated in FIG. 14, in the projection system 100 of the second embodiment, the control device 3 includes a gesture determination unit 415. Furthermore, in the second embodiment, sensors (operation detection units) 468 and 469 for detecting a user's gesture are provided in the booth 14 as illustrated in FIG. 15.

The sensor 468 is provided on the ceiling surface 14C to be closer to the door 9 than the toilet bowl 41, and determines the distance from the ceiling surface 14C to an object exiting on the door 9 side, that is, the position of the object in the height direction (vertical direction). The sensor 468 is provided on the left-side wall 14L to be closer to the door 9 than the toilet bowl 41, and determines the distance from the left-side wall 14L to the object existing on the door 9 side, that is, the position of the object in the horizontal direction.

The two-dimensional position in a height direction and a vertical direction of a site such as a user's arm extended to the door 9 side (that is, the projection target surface side) is periodically detected by these sensors 468 and 469, whereby the motion of the site can be detected. Note that the detection unit that detects the motion of the user is not limited to the distance sensor, and a light projector may be provided on the ceiling surface 14C to project a predetermined pattern of infrared rays into the booth, image the pattern projected onto the object in the booth by a camera, compare this predetermined pattern with the pattern projected on the object, and periodically determine the position of the object existing on the toilet bowl 41 from the difference between the patterns, thereby detecting the action of the user.

Furthermore, the position of the object exiting on the toilet bowl 41 may be periodically determined by a ToF distance image sensor to determine the action of the object (user). In this case, a human shape may be stored as a standard pattern to identify an object matching the standard pattern as a user by pattern matching, and recognize a site of the object matching an arm portion of the standard pattern to determine the action of the arm portion.

The gesture determination unit 415 determines whether the user's action detected by the sensors 468 and 469 corresponds to a predetermined gesture. The predetermined gesture is, for example, a gesture of swinging the site extended to the projection target surface side from side to side or swinging up and down, stopping the site extended to the projection target surface side for a predetermined time or more while pointing to a choice displayed on the projection image, etc.

When it is determined by the gesture determination unit 415 that the predetermined gesture has been performed, the image control unit 412 executes processing assigned to the gesture. For example, in the case of a swing gesture in the horizontal direction, the image control unit 412 executes fast-forwarding or fast-reversing of an image, and in the case of a swing gesture in the height direction, the image control unit 412 adjusts sound volume. Moreover, in the case of a gesture of stopping for a predetermined time or more while pointing to a choice (selection operation), the image control unit 412 executes processing in the case of the selection of the choice.

As described above, according to the second embodiment, the user can perform an operation on the image by only a gesture without touching the operation unit or the like, and can easily and hygienically operate even during defecation.

### Third Embodiment

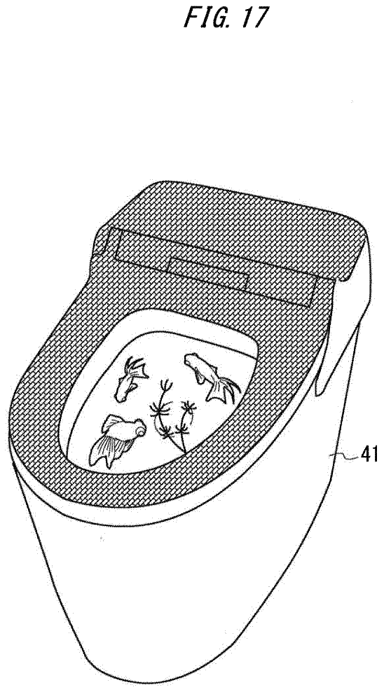

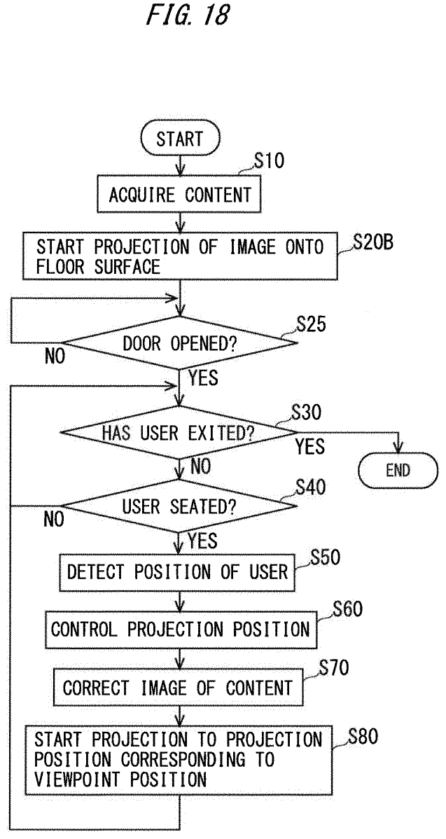

As compared with the first or second embodiment described above, a third embodiment is added with a configuration for projecting an image on the toilet bowl 41 until the user is seated on the toilet bowl 41. Note that the other configuration is the same, and thus the same components are represented by the same reference numerals and symbols, and duplicative description thereon is omitted. FIG. 16 is a diagram illustrating a projection method in the third embodiment, and FIG. 17 is a diagram illustrating an example of an image to be projected onto the toilet bowl.

First, when the detection unit 46 such as a human detection sensor installed in the booth 14 detects doorway of a user, the control device 3 starts processing of FIG. 16. First, the control device 3 acquires content from the content server 2 or the memory (step S10). At this time, in addition to an image to be projected onto the inner wall of the door 9 described above, the control device 3 also acquires an image to be projected onto the toilet bowl 41. Then, the control device 3 sets the projection position onto the toilet bowl 41, projects the image onto the toilet bowl 41, and causes sound information of the content to be output from the speaker 433 to start the reproduction of the content (step S20A). At this time, since it can be estimated that the user has entered the booth 14, it is before the user is seated on the toilet bowl 41, and thus the user is standing while facing the toilet bowl 41 from the doorway side. Therefore, distortion correction of the image is performed with the viewpoint position set as the doorway 4 side, and the image is projected onto the toilet bowl 41. For example, as illustrated in FIG. 17, goldfishes displayed in the bowl portion of the toilet bowl 41 to display a pattern like a fish bowl on the toilet seat. Note that the image to be projected is not limited to the goldfish, but may be any image such as a sea floor or coral reef.

Next, in the same manner as described above, the control device 3 determines whether the user has exited from the booth 14 (step S30) and whether the user has been seated on the toilet bowl 41 (step S40). Here, when the user has not been seated (step S40, No), the control device 3 returns step S30.

When it is determined that the user has been seated on the toilet bowl 41 (step S40, Yes), the control device 3 stops the projection of the image onto the toilet bowl 41, and the subsequent processing (steps S50 to S80) projects the image onto the projection position corresponding to the viewpoint position of the user as in the case of FIG. 13 described above. Note that the third embodiment represents an example in which the projection of the image onto the toilet bowl 41 and the projection of the image onto the inner wall of the door 9 are performed by one projector 1. However, a plurality of projectors may be provided to perform the projection of the image onto the toilet bowl 41 and the projection of the image onto the inner wall of the door 9 by different projectors.

As described above, in the third embodiment, an image can be effectively presented by projecting the image onto the toilet bowl 41 which a user entering the booth 14 surely views. For example, by displaying as if living beings inhabit in the toilet bowl 41, a clean impression can be given to the user. In addition, by displaying an idyllic image like a goldfish or the like, an effect of relaxing the user can be achieved. Furthermore, when an image including a water surface is projected like an image in which goldfishes swimming under the water surface are overlooked like a bird's-eye view, by projecting the image so that the water surface in the image and the sealing water in the toilet bowl 41 coincide with each other, augmented reality (AR) is given to the user as if goldfishes swim under the actual sealing water, and the user is caused to be interested in the projection image, whereby the degree of expectation for an image to be next projected onto the inner wall of the door 9 or the like can be enhanced.

### Fourth Embodiment

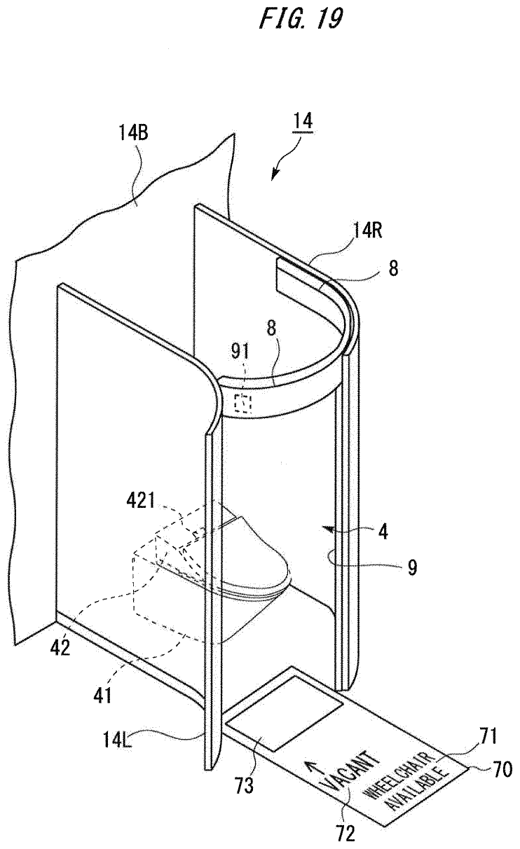

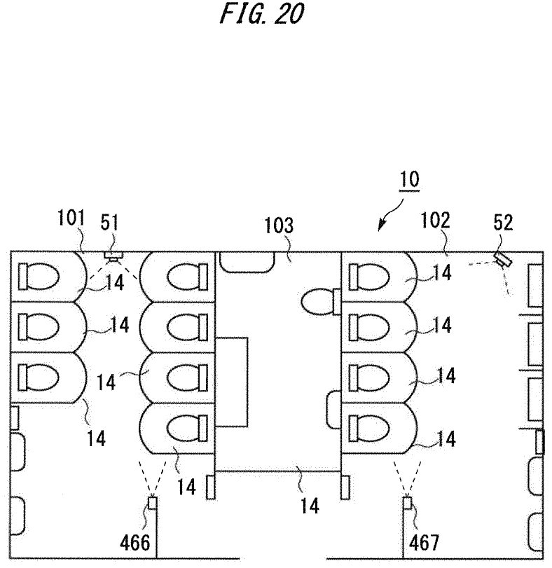

As compared with any of the first to third embodiments described above, a fourth embodiment is added with a configuration for projecting an image onto the floor surface 14F when the door 9 is open. Note that the other configuration is the same as any of the first to third embodiments described above, and thus the same components are represented by the same reference numerals and symbols, and duplicative description thereof is omitted. FIG. 18 is a diagram illustrating a projection method in the third embodiment, FIG. 19 is a diagram illustrating an example of an image to be projected on the floor surface 14F, and FIG. 20 is a diagram illustrating an arrangement example of sensors for detecting a user approaching the booth 14.

In the fourth embodiment, human detection sensors 466 and 467 are provided outside booths 14 to detect that a user has entered a predetermined area close to a booth 14, that is, the user has approached a booth 14, and projection of an image 70 onto the floor surface 14F is started. Specifically, the sensors 466 and 467 are provided in the vicinity of the doorways of the female toilet facilities 101 and the male toilet facilities 102. When the sensor 466 detects existence of a user, it is detected that the user has approached a booth 14 in the female toilet facilities 101, and when the sensor 467 detects existence of a user, it is detected that the user has approached a booth 14 in the male toilet facilities 102. Not limited to the human detection sensors, cameras 51 and 52 may be provided in the toilet facilities 101 and 102 so that when it is recognized that a user appears in a captured image by pattern recognition, the user has approached a booth 14. A user on a wheelchair may be detected based on images captured by the cameras 51 and 52.

When the control device 3 detects that a user has approached a booth 14 by the sensors 466 and 467 or the cameras 51 and 52, the control device 3 starts the processing of FIG. 18. The control device 3 first acquires content from the content server 2 or the memory (step S10). At this time, in addition to an image to be projected onto the inner wall of the door 9 described above, the control device 3 also acquires an image to be projected onto the floor surface 14F. Then, the control device 3 sets the projection position onto the floor surface 14F, causes the image 70 to be projected onto the floor surface 14F, and causes sound information of the content to be output from the speaker 433 to start reproduction of the content (step S20B). At this time, since it can be estimated that the user has entered the toilet facilities 101, 102, it is before the user enters a booth 14 and the user is standing while facing the doorway 4 of the booth 14, image distortion correction is performed while the viewpoint position is set to the doorway side of the toilet facilities 101, 102, and the image is projected onto the floor surface 14F. For example, as illustrated in FIG. 19, information 71 indicating that the booth is vacant, that is, the booth is available, information 72 indicating whether the booth can be used on a wheelchair, etc. are displayed. Not limited to this style, the position of a washing button, how to use a controller 43, and the like may be displayed as the image 70 to be projected. When a user on a wheelchair approaches, an image 73 explaining the approaching direction, the stop position and how to move to a toilet bowl 41, and the like may be displayed. Furthermore, when the user on the wheelchair is detected by the cameras 51 and 52, booths 14 available with the wheelchair out of the booths in the toilet facilities are identified, and projection onto the floor surface 14F is performed on only the booths 14 available with the wheelchair to indicate that the booths 14 are available. In the case where a user who does not sit on a wheelchair is detected by the cameras 51 and 52, when both of a booth 14 available with the wheelchair and a booth 14 unavailable with the wheelchair are vacant, the control device 3 controls to project onto the floor surface 14F for the booth 14 unavailable with the wheelchair so as to indicate that the booth 14 is vacant, and not to perform display of vacancy for the booth 14 available with the wheelchair. Note that in the case where a user who does not sit on a wheelchair is detected, when only a booth 14 available with the wheelchair is vacant, the control device 3 causes the projection onto the floor surface 14F to be performed for the booth 14 available with the wheelchair, indicating that the booth 14 is vacant.

Next, the control device 3 detects whether the door 9 is closed by the opening and closing sensor or the like of the door 9 (step S25). Here, when the door 9 is not closed (step S25, No), the control device 3 continues the display of the image started in step S20B.

When the door 9 is closed (step S25, Yes), the control device 3 stops the projection of the image onto the floor surface 14F and controls the projection position changing unit 16 of the projector 1 to set the projection target surface to the inner wall of the door 9 and project an image. At this time, since it can be estimated that the user has entered the booth 14, it is before the user sits on the toilet bowl 41 and the user is standing, the image is projected to a high position, for example, the maximum height of the adjustment range (for example, 1400 mm). Note that the projection position is not limited to the above position, and it may be set to a middle position in the adjustment range, or an average of viewpoint positions (heights) detected within a predetermined period may be determined to set the projection position according to the averaged viewpoint position. The step S30 and subsequent steps are the same as the first to third embodiments described above.

As described above, according to the fourth embodiment, an image as to whether a booth is available or not, etc. can be presented to a user located outside the booth. In particular, by projecting images such as the position of the washing button, how to use the controller 43, etc. onto the floor surface 14F, the user can know these when the user enters the booth, and focus on viewing of the images displayed on the wall surface when the user has been seated. Furthermore, by recognizing a user on a wheelchair and indicating how to use with the wheelchair, etc., the convenience of the user on the wheelchair is enhanced.

<Others>

The present invention is not limited to only the illustrated examples described above, and it goes without saying that various modifications can be made without departing from the subject matter of the present invention. Moreover, although the example of the toilet booth provided with the toilet bowl is mainly illustrated as the booth 14 in the foregoing embodiments, the booth 14 is not limited to the toilet booth, and the booth 14 may be a place which a user uses alone, such as a shower booth, a dressing room, a fitting room, or a capsule hotel.

### DESCRIPTION OF THE REFERENCE NUMERALS AND SYMBOLS

1 projector
2 content server
3 control device
3 present embodiment
4 doorway
5 network
6 relay device
7 toilet equipment
8 guide rail
9 door
41 toilet bowl
42 toilet seat device
46 detection unit
61 operation panel
63 door driving unit
91 lock
100 projection system

1. A projection system comprising:
a detection unit that detects a position of a user who uses a booth;
an image projection unit that projects an image onto a projection target surface determined for the booth; and
a correction unit that performs correction of distortion of the image according to the position of the user.

2. The projection system according to claim 1, further comprising a movement control unit that moves a projection position based on the position of the user, wherein the correction unit corrects the image to be projected to the projection position based on the projection position.

3. The projection system according to claim 2, wherein the detection unit detects a viewpoint position of the user as the position of the user, and the movement control unit moves the projection position based on the detected viewpoint position of the user.

4. The projection system according to claim 1, wherein:
the image projection unit is provided at an upper portion of the booth,
when the user enters the booth and closes a door at a doorway of the booth, the image projection unit projects the image onto an inner wall of the door set as the projection target surface, and
when the user opens the door and exits, the image projection unit projects the image from the upper portion of the booth through the doorway onto a floor surface, the floor surface set is set as the projection target surface.

5. The projection system according to claim 1, wherein the booth comprises a toilet bowl, and wherein an upward surface of the toilet bowl is set as the projection target surface when the user is not seated on the toilet bowl.

6. The projection system according to claim 1, further comprising:
an action detection unit that detects an action of the user;
a gesture determination unit that determines whether an action of the user corresponds to a predetermined gesture; and
an image control unit that controls the image to be projected according to the gesture in response to the action of the user corresponding to the gesture.

7. A projection method, the method executed of by a computer, the method comprising:
detecting a position of a user in a booth;
causing projection of an image onto a projection target surface of the booth; and
performing correction of distortion of the image according to the position of the user.
